(19) United States
(12) Patent Application Publication
(10) Pub. No.: US 2011/0085777 A1
(43) Pub. Date: Apr. 14, 2011

(54) Systems and Methods for Generating Compact Multiangle Video

(75) Inventors: Albert Azout, New York, NY (US); Ari Goldberg, New York, NY (US); Bill Schultz, New York, NY (US)

(73) Assignee: StyleCaster Media Group LLC

(21) Appl. No.: 12/841,541

(22) Filed: Jul. 22, 2010

Related U.S. Application Data
(60) Provisional application No. 61/250,653, filed on Oct. 12, 2009.

(51) Int. Cl. H04N 5/77; H04N 7/18

(52) U.S. Cl. 386/224; 348/61; 386/E05.069; 348/E07.085

(57) ABSTRACT

Provided are systems and methods for providing expedited production of compact multi-angle video. Methods include capturing video content of a moving video subject and a background portion that is proximate the moving video subject as digital video data and generating a motion video data file from multiple sequentially numbered transparent background still image data files that correspond to the digital video data.

### RELATED APPLICATIONS

This non-provisional patent application claims priority to U.S. Provisional Application Ser. No. 61/250,653, filed Oct. 12, 2009, the disclosure of which is hereby incorporated herein by reference as if set forth fully herein.

### FIELD OF INVENTION

The present invention relates to multimedia and, more particularly, to video production methods and systems.

### BACKGROUND

The growing presence of computer networks such as the Internet, intranets and extranets has resulted in the dissemination of information and data at ever increasing rates. In this regard, even information that may be temporally sensitive and thus may have a short period of relevance may be suited for broadcast using, for example, the Internet. For example, news such as financial data, social trends, fashions, etc. may have very limited periods of relevance. Typically, such temporally sensitive information may be typically produced and/or provided as it becomes available. As such, the dwell time from capturing the information to making the information available may be limited and the information may be provided in a piecemeal fashion. In this regard, providing a high volume of relevant information may provide challenges.

### SUMMARY

Some embodiments of the present invention include systems for providing expedited production of compact multi-angle video. Embodiments of such systems may include a video image capture device that is configured to capture a continuous visual image of a video subject in front of a substantially monochromatic background and to generate digital video data corresponding to the continuous visual image at a recording rate defined in frames per second. Embodiments may include a dynamic stage that is configured to move the video subject relative to the video image capture device in a cyclical manner and a selective signal amplifier that is configured to receive the digital video data from the video image capture device and to amplify a portion of the digital video data corresponding to reflected light having a dominant wavelength that corresponds to the substantially monochromatic background. A computing device may be operable to execute at least one video editing and/or processing application and a video capture interface may be configured to be communicatively coupled with the computing device and to receive the selectively amplified digital video data so that the video editing and/or processing application may be used to generate a compact multi-angle video of the video subject including a transparent background.

Some embodiments of the present invention include methods of generating a multi-angle video. Such methods may include capturing video content of a moving video subject and a background portion that is proximate the moving video subject as digital video data. A motion video data file may be generated from multiple sequentially numbered transparent background still image data files that correspond to the digital video data.

In some embodiments, capturing the video content of the moving video subject includes moving the video subject relative to a video capture device using a dynamic stage. Some embodiments provide that moving the video subject using the dynamic stage includes rotating the video subject relative to the video capture device.

Some embodiments provide that generating the motion video data file comprises selectively amplifying the digital video data to amplify the background portion of the digital video data. In some embodiments, the background portion is configured to reflect light at a dominant wavelength and portions of the digital video data that reflect light at that dominant wavelength are amplified.

In some embodiments, the selectively amplified digital video data may be edited to remove the selectively amplified portions and to generate final length transparent background video data. Some embodiments provide that selectively amplified digital video data may be edited to reduce a length of the digital video data to generate final length video data.

In some embodiments, the final length transparent background video data is converted into multiple layers of still image data files and each of the still image data files is edited to reduce an image size of each of the still image data files to generate the sequentially numbered transparent background still image data files.

Some embodiments provide that respective ones of the sequentially numbered transparent background still image files include at least one bitmap and/or a portable network graphics (PNG) file. In some embodiments, the sequentially numbered transparent background still image files include a file including multiple layers that correspond to the sequentially numbered transparent background still image files. Some embodiments include assembling the sequentially numbered transparent background still image data files into the motion video data file.

Some embodiments of the present invention include systems for providing expedited production of multi-angle video. Embodiments of such systems may include a video image capture device that is configured to capture a continuous visual image of a video subject in front of a substantially monochromatic background and generate digital video data corresponding to the continuous visual image at a recording rate defined in frames per second. A dynamic stage may be configured to move the video subject relative to the video image capture device. A signal processing device may be configured to receive the digital video data and to generate a multi-angle video of the video subject including a transparent background.

Some embodiments provide that the signal processing device includes a selective signal amplifier that is configured to receive the digital video data from the video image capture device. The selective signal amplifier may amplify a portion of the digital video data corresponding to reflected light having a dominant wavelength that corresponds to the substantially monochromatic background.

In some embodiments, the signal processing device includes a computing device that is operable to execute at least one video editing and/or processing application. A video capture interface may be configured to be communicatively coupled with the computing device and to receive a selectively amplified digital video data so that the video editing and/or processing application may be used to generate the compact multi-angle video of the video subject including a transparent background.

Embodiments of the present invention are directed to methods of generating a multi-angle video. Such methods may include moving a video subject on a dynamic stage and capturing video of the moving video subject as digital video data. Portions of the digital video data are selectively amplified. The selectively amplified digital video data is edited to remove the selectively amplified portions and to generate final length transparent background video data. The final length transparent background video data is converted into multiple layers of still image data files. Each of the still image data files may be edited to reduce an image size of each of the still image data files to generate multiple sequentially numbered transparent background still image data files. The sequentially numbered transparent background still image data files may be assembled into a motion video data file.

It is noted that aspects of the invention described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

FIG. 1 is a flowchart illustrating systems, apparatus and operations for generating compact multi-angle video in accordance with some embodiments of the present invention.

FIG. 2 is a block diagram illustrating systems/methods for providing expedited production of compact multi-angle video according to some embodiments of the present invention.

FIG. 3 is a flowchart illustrating operations for generating a multi-angle video according to some embodiments of the present invention.

FIG. 4 is a line drawing of a perspective view of a dynamic stage 202 in accordance with some embodiments of the present invention.

FIG. 5 is a flowchart illustrating operations for generating multi-angle video according to some embodiments of the present invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail. While various modifications and alternative forms of the embodiments described herein may be made, specific embodiments are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, and/or storage medium. More specific examples (a non-exhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

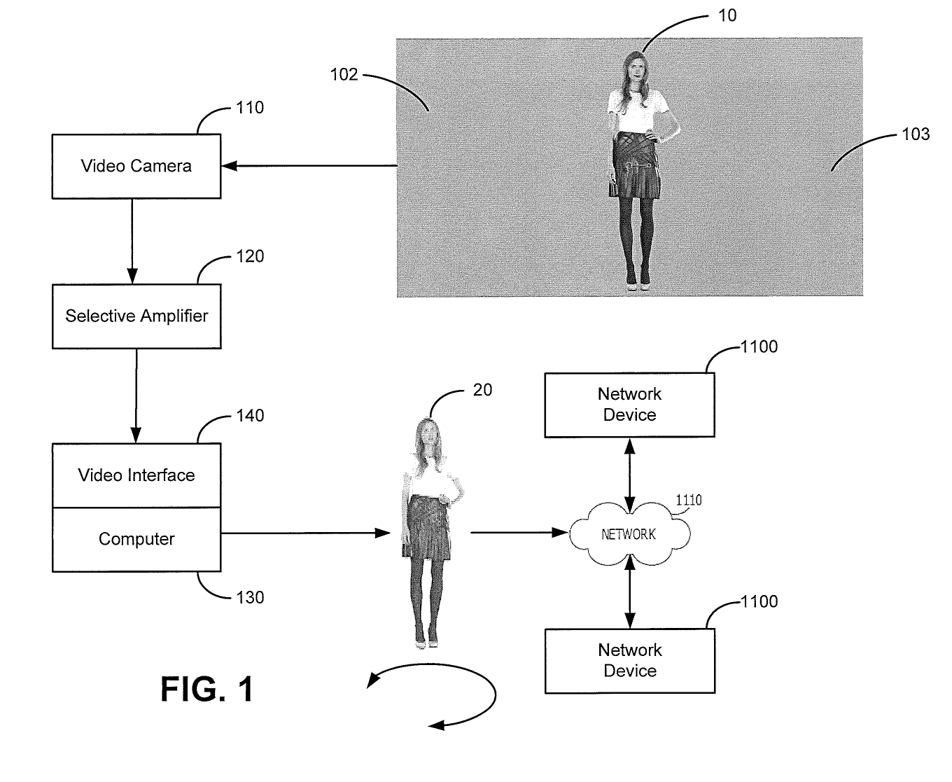

Reference is now made to FIG. 1, which is a flowchart illustrating systems, apparatus and operations for generating compact multi-angle video in accordance with some embodiments of the present invention. A video subject 10, such as, for example, a fashion model, may be provided to model a particular fashion ensemble. The video subject 10 may be on a dynamic stage 102 that is configured to move the video subject 10 relative to a video camera 110. Some embodiments provide that the dynamic stage 102 may move the video subject 10 in a cyclical manner relative to the video camera 110, such as rotating the video subject in a continuous and/or variable manner. The rotation may be performed at a specified speed in order to capture a specific amount of video content that may be related to, for example, a desired final video length and/or a recording rate or rate of image capture by the video camera 110, which may be expressed as a quantity of images per unit time, such as, for example, frames per second, among others. In some embodiments, the rotation may be performed in a first rotational direction and/or a second rotational direction. Some embodiments provide that the dynamic stage 102 may be able to operate at a variety of rotational speeds and may be controlled either locally or remotely by a wired and/or wireless controller.

By rotating the video subject 10 relative to the video camera 110, a multi-angle video of the video subject 10 may be generated that includes a continuous view from 360 degrees around the video subject 10. This may provide significant improvement over conventional methods of multi-angle video, which may rely on multiple still photos generated by multiple cameras placed at specific angles around an object. Although such techniques may be acceptable for providing several perspectives of the object, they may be inadequate for capturing video content of a video subject 10 such as, for example, a live model. For example, a live model may be dynamic and change positions, poses, postures, expressions, and/or a direction of attention throughout the video segment. For example, a viewing experience may be enhanced by a video of a live model that appears to engage a viewer.

In some embodiments, the video subject 10 is positioned in front of a substantially monochromatic background 103. The substantially monochromatic background 103 may be incorporated into the dynamic stage 102 and may include dimensional and surface features that are configured to reduce and/or eliminate surface shadows and/or visible transitions that may result from a corner or other sharp surface transition, among others.

The video camera 110 may generate digital video data corresponding to the continuously dynamic visual image of the video subject 10. The digital video data may be output to a selective amplifier 120. In some embodiments, the selective amplifier 120 may be configured to amplify the portions of the digital video data that correspond to the substantially monochromatic background. In some embodiments the substantially monochromatic background may correspond to a green screen or a blue screen that may be used in a typical cinemaphotographic process.

For example, in a blue-screen cinemaphotographic process, whatever appears in a scene that is colored blue is excluded from the video camera shooting the scene, and in the final film the excluded area may be supplanted by an image and/or images taken by another camera to create a composite image. The area which is excluded by the blue-screen may be in the foreground and/or in the background of the scene.

One well-known blue-screen matte system is the Chromakey system, which is used in TV and in cinemaphotography to produce a composite color image in which the separate image elements are matted together. In the Chromakey system, the camera yields an image of a performer in front of a blue screen. A second camera provides the background of the composite image. When applied to TV cameras, the composite images may appear instantly on a video monitor screen.

A green-screen system that may be used as an alternative to the Chromakey system is the Ultimatte electronic compositor, invented by Petro Vlahos, and is now in widespread use. The Ultimatte compositor produces a high-quality composite image in which the matte lines typical of a Chromakey system are absent. The various types of blue-screen matte cinemaphotography systems that are now in use are disclosed in the text “The Technique of Special Effects Cinematography” (Fourth Edition) by Raymond Fielding—Focal Press.

A technique in accordance with the invention makes use of a green-screen and/or blue-screen matte cinematography system of any known type, and is not limited to a Chromakey or Ultimatte system for this purpose. Thus while the system may be described as being of the green screen type in which surfaces having a green color are blocked out of the scene being filmed, a matte effect may be obtained by using a color other than green for this purpose.

A computer 130 or similar computing device that is operable to execute at least one video editing and/or processing application may be communicatively coupled to a video capture interface 140. The video capture interface 140 may be configured to receive the selectively amplified digital video data so that one or more video editing and/or processing applications may be used to generate a compact multi-angle video 20 of the video subject 10 with a transparent background.

The compact multi-angle video 20 may then be distributed within a temporally relevant window to various network devices 1100 via a network 1110, such as, for example, the Internet. Operations and processes corresponding to the video processing are described in detail below.

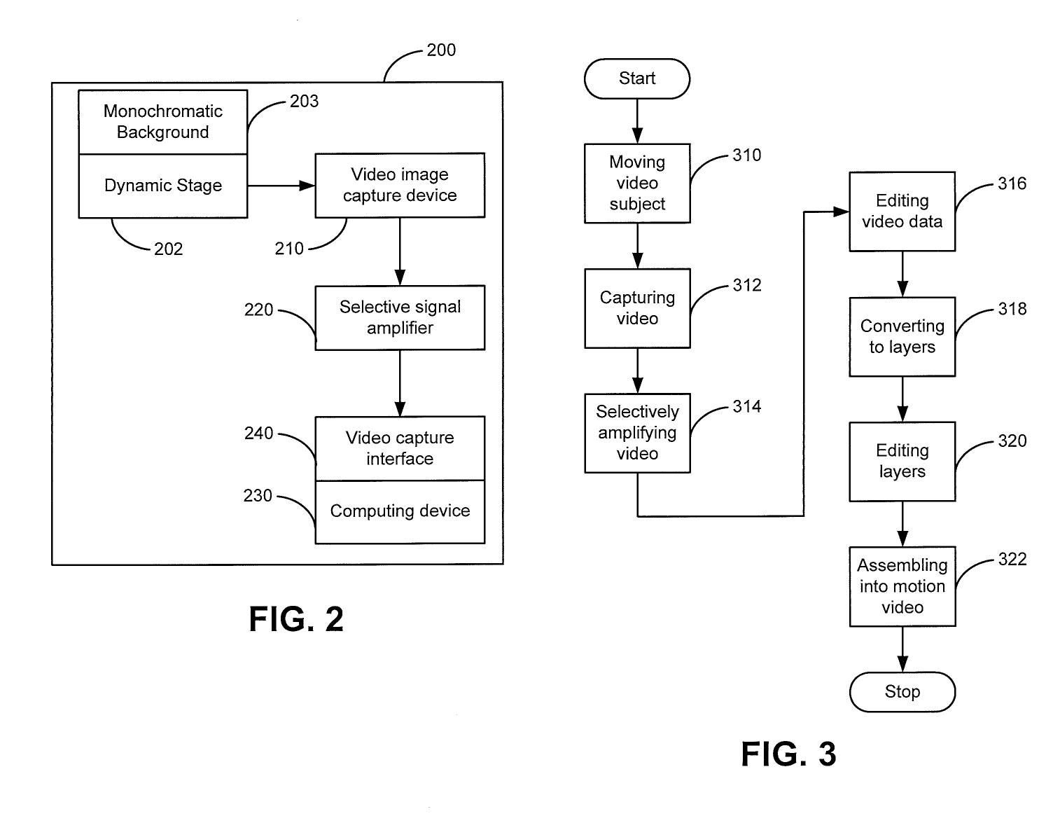

Reference is now made to FIG. 2, which is a block diagram illustrating systems/methods for providing expedited production of compact multi-angle video according to some embodiments of the present invention. The system 200 includes a video image capture device 210 that is configured to capture a continuous visual image of a video subject positioned in front of a substantially monochromatic background. Some embodiments provide that the substantially monochromatic background includes a blue screen and/or a green screen as discussed above regarding a Chromakey and/or Ultimatte systems and/or techniques. The video image capture device 210 is operable to generate digital video data corresponding to the continuous visual image at a recording rate that may be defined in, for example, frames per second. In some exemplary embodiments, the recording rate may be 15, 20, 30, 45 or 60 frames per second, among others. The digital video data may be generated, stored and/or encoded using any of a number of digital video formats, standards and/or protocols that are currently used or may be developed in the future.

The system 200 may include a dynamic stage 202 that may be configured to move the video subject relative to the video image capture device 210. The dynamic stage 202 may move the video subject relative to the video image capture device 210, including, but not limited to, rotating the video subject in a continuous manner. The rotation may be performed at a specified speed in order to capture a specific amount of video content that may be related to, for example, a desired raw and/or final video length and/or a recording rate or rate of image capture by the video image capture device 210. In some embodiments, the rotational speed may be varied and/or variable. Some embodiments provide that the recording rate may be expressed in frames per second, among others. In some embodiments, the rotation may be performed in a first rotational direction and/or a second rotational direction. The dynamic stage 202 may include, be used in conjunction with and/or integrated into a monochromatic background 203 that is configured to be used in a cinemaphotographic matte process.

A selective signal amplifier 220 may receive the digital video data from the video image capture device 210 and selectively amplify a portion of the video data that corresponds to reflected light having a dominant wavelength that corresponds to the substantially monochromatic background 203. In some embodiments, the selective signal amplifier 220 may include an Ultimatte device, but the invention is not so limited. For example, some embodiments provide that the portion of the digital video data that is selectively amplified corresponds specifically to a green background.

The selectively amplified digital video data may be received into a computing device 230 via a video capture interface 240 that is communicatively coupled thereto. The computing device 230 may be operable to execute at least one video editing and/or processing application to generate a compact multi-angle video of the video subject with a transparent background.

Reference is now made to FIG. 3, which is a flowchart illustrating operations corresponding to methods of generating a multi-angle video according to some embodiments of the present invention. Operations according to such methods may include moving a video subject relative to a video image capture device on a dynamic stage (block 310). In some embodiments, a video subject may be sufficiently dynamic and thus a dynamic stage may not be provided and/or used.

Video of the moving video subject may be captured as digital video data (block 312). Some embodiments provide that the length of the video may correspond to the length of the desired final video and may be coordinated with the movement of the video subject. For example, the dynamic stage may be configured to rotate the video subject 360 degrees over a fixed time period, such as eight seconds and raw video data may be taken for 16 seconds, the time it takes for the video subject to complete two full revolutions. In some embodiments, the rotation rate may be six seconds per revolution and the raw video capture time may be 12 or 18 seconds corresponding to one or two complete revolutions. Some embodiments provide that, in the case of a cyclical motion of the video subject relative to the video image capture device, the raw video data may be approximately at least an integer product of the period of the cyclic activity.

The digital video data may be selectively amplified (block 314). In some embodiments, portions of the digital video data corresponding to a color of a substantially monochromatic background may be amplified. For example, a blue or green background as discussed above regarding Chromakey and Ultimatte may be used and the selective amplifier may be configured to amplify the portions of the digital video data corresponding to the blue and/or green background.

In some embodiments, the selectively amplified digital video data may be edited from raw video data to an edited length and/or to key out the blue or green background color (block 316). The resulting edited digital video data may then include a transparent background and may be the desired final length. For example, a raw video data length of 15 seconds might be reduced to a final length of five seconds. In this manner final length transparent video data may be provided. Some embodiments may provide that the selectively amplified digital video data may be edited using an automated image processing application and/or manually by a user using a video editing application.

The selectively amplified digital data may be converted into multiple layers of still image data files (block 318). For example, some embodiments provide that the final length transparent video data may include a QuickTime Movie file that may be imported into a graphics application, such as, for example, Photoshop, which may create a single file including a layer for each frame captured in the video. For example, if the recording rate is 30 frames per second and the video is six seconds in length, then the single file may include approximately 180 different layers.

The multiple layers may be edited to reduce an image size of each of the layers (block 320). In some embodiments, editing may include simultaneously cropping each of the multiple layers of still image data files. In such embodiments, each of the layers may be reviewed to ensure that no portion of the video subject is cropped out of any of the images. Some embodiments provide that each layer may be exported into a separate image or graphics file such as a bitmap and/or a portable network graphics (PNG) file, among others. In some embodiments, each of the image files may be sequentially numbered to preserve the original order corresponding to the video.

Some embodiments provide that editing the multiple layers may include reducing the image size of the multiple layers. For example, some embodiments provide that the layers may be reduced to a thumbnail sized file or some semblance thereof. In some embodiments, a 600×900 pixel multi-layer file may be reduced to a 250×370 pixel multi-layer file. Although the reduction is described as being performed on the multi-layer file, the invention is not so limited. For example, the multiple separate image files described above may be reduced individually. Regardless of the order of operations, multiple reduced size, transparent background image files may be generated.

The multiple image files may be assembled into a motion video data file (block 320). For example, in some embodiments, a motion video data file may include a multimedia format, such as, for example, a Flash movie among others. In this manner, a compact multi-angle video with background transparency may be provided. Some embodiments provide that several of the operations discussed herein may be automated using batch and/or script programming. For example, converting the edited video into layers (block 318), editing the layers (block 320) and/or assembling the layers into a motion video (block 322) may be performed automatically and without substantive intervention by a user. In this regard, the video asset may be delivered and/or in use very shortly after the raw video data is initially captured. Accordingly, a large quantity of video assets may be produced in a relatively short amount of time.

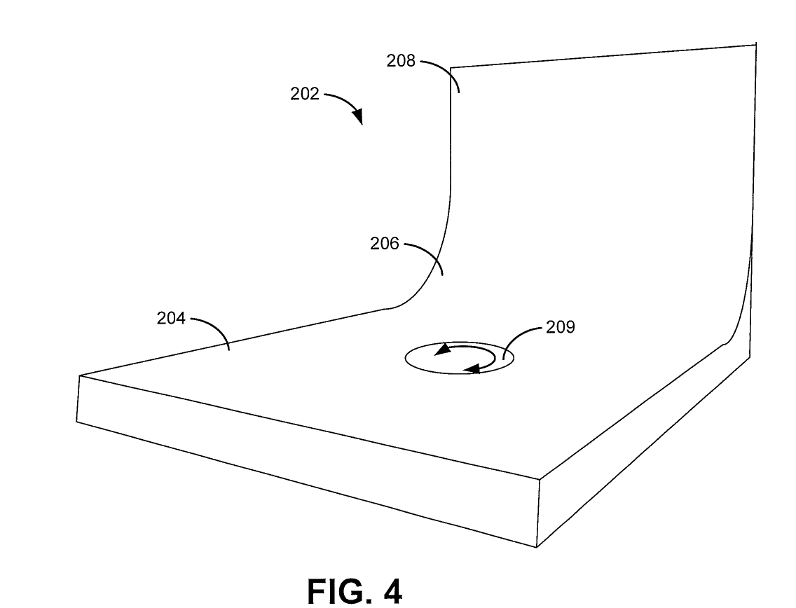

Reference is now made to FIG. 4, which is a line drawing of a perspective view of a dynamic stage 202 in accordance with some embodiments of the present invention. The stage 202 may include a riser surface 204 that is substantially horizontal and may be raised some nominal distance from the floor. For example, some embodiments provide that the riser surface 204 may be raised above the floor by a distance in a range from about six inches to about 18 inches. In some embodiments, the riser surface 204 may be covered with and/or colored in a blue and/or green shade as discussed above regarding cinemaphotographic matte techniques.

The stage 202 may include one or more background surfaces 208 that may be substantially vertical. In some embodiments, the background surfaces 208 may be covered with and/or colored in a blue and/or green shade as discussed above regarding the riser surface 204. Some embodiments provide that the stage 202 may include a transition portion 206 that may include a curved section. The transition portion 206 may be configured to reduce and/or eliminate shadows and/or visible transitions between the riser surface 204 and the one or more background surfaces 208.

The stage 202 may include a dynamic portion 209 that is configured to move a video subject, or some portion thereof, relative to a video camera (not shown). Although illustrated as generally circular, the dynamic portion 209 is not so limited. Similarly, although the motion, as illustrated by the arrow, is illustrated as generally rotational, the motion is not so limited. For example, instead of a turntable type device as illustrated, the dynamic portion 209 may include a substantially linear conveyor type device (not illustrated). In such embodiments, the video subject may be recorded while performing some moving activity such as, for example, walking, running, crawling, and/or riding some mobile-type device. Such mobile devices may include bicycles, skates, skateboards, and/or scooters, among others. Some embodiments provide that the dynamic portion 209 may be covered with and/or colored in a blue and/or green shade as discussed above regarding the riser surface 204. In this manner, the dynamic portion 209 may be keyed out (i.e., made transparent) during a subsequently performed editing process along with the riser, transition and background portions 204, 206, 208 of the stage 202.

As described herein, the present invention may provide compact multi-angle videos that can be produced on a massive scale by virtue of the reduced time between when the initial video data is captured and when an asset becomes available for publication. In this regard, according to embodiments described herein, temporally relevant, transparent, 360 degree videos of live video subjects, such as live models, may be generated and provided for distribution over, for example, the Internet on a massive scale.

Some operations described herein may be performed, deployed and/or executed any type and form of computing device, such as a computer, network device or appliance capable of communicating on any type and form of network and performing the operations described herein.

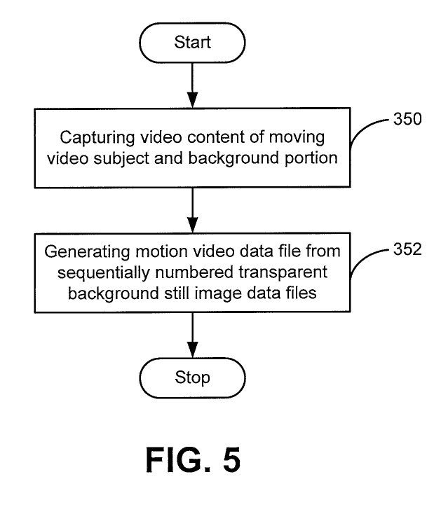

Reference is now made to FIG. 5, which is a flowchart illustrating operations for generating multi-angle video according to some embodiments of the present invention. Video content of a moving video subject and a background portion that is proximate the moving video subject is captured as digital video data (block 350). Some embodiments provide that the video subject may be moved relative to a video capture device using a dynamic stage. For example, a dynamic stage may be used to rotate the video subject relative to the video capture device. Some embodiments provide that the dynamic stage may provide a substantial linear movement to allow the video subject to move without leaving the proximity of the dynamic stage.

A motion video data file is generated from multiple sequentially numbered transparent background still image data files that correspond to the digital video data (block 352). The digital video data may be selectively amplified to amplify the background portion of the digital video data. For example, some embodiments provide that the background portion reflects light at a dominant wavelength. In this regard, portions of the digital video data that reflect light at that dominant wavelength may be amplified.

The selectively amplified digital video data may be edited to remove the selectively amplified portions and to generate final length transparent background video data. For example, in some embodiments, editing includes reducing a length of the digital video data to generate final length video data. The final length transparent background video data may be converted into multiple layers of still image data files, each of which may be edited to reduce an image size thereof to generate the sequentially numbered transparent background still image data files. Some embodiments provide that the sequentially numbered transparent background still image files include may include bitmap and/or a portable network graphics (PNG) file, among others.

Some embodiments provide that the sequentially numbered transparent background still image files include a file including multiple layers that correspond to ones of the sequentially numbered transparent background still image files. The sequentially numbered transparent background still image data files may be assembled into the motion video data file.

In the drawings and specification, there have been disclosed embodiments of the invention and, although specific terms are employed, they are used in a generic and descriptive sense only and not for purposes of limitation, the scope of the invention being set forth in the following claims.

That which is claimed:

1. A system for providing expedited production of compact multi-angle video, the system comprising:
a video image capture device that is configured to capture a continuous visual image of a video subject in front of a substantially monochromatic background and generate digital video data corresponding to the continuous visual image at a recording rate defined in frames per second;
a dynamic stage that is configured to move the video subject relative to the video image capture device in a cyclical manner;
a selective signal amplifier that is configured to receive the digital video data from the video image capture device and to amplify a portion of the digital video data corresponding to reflected light having a dominant wavelength that corresponds to the substantially monochromatic background to provide selectively amplified digital video data; and
a computing device that is configured to execute at least one video editing and/or processing application; and
a video capture interface that is configured to receive the selectively amplified digital video data and provide the selectively amplified digital video data to a computing device that is configured to execute at least one video editing and/or processing application to generate a compact multi-angle video of the video subject with a transparent background.

2. A method of generating a multi-angle video, the method comprising:
capturing video content of a moving video subject and a background portion that is proximate the moving video subject as digital video data; and
generating a motion video data file from a plurality of sequentially numbered transparent background still image data files that correspond to the digital video data.

3. The method of claim 2, wherein capturing the video content of the moving video subject comprises moving the video subject relative to a video capture device using a dynamic stage.

4. The method of claim 3, wherein moving the video subject relative to a video capture device using the dynamic stage comprises rotating the video subject relative to the video capture device.

5. The method of claim 2, wherein generating the motion video data file comprises selectively amplifying the digital video data to amplify the background portion of the digital video data.

6. The method of claim 5, wherein the background portion is configured to reflect light at a dominant wavelength and portions of the digital video data that reflect light at that dominant wavelength are amplified.

7. The method of claim 5, wherein generating the motion video data file further comprises editing the selectively amplified digital video data to remove the selectively amplified portions and to generate final length transparent background video data.

8. The method of claim 7, wherein editing the selectively amplified digital video data further comprises reducing a length of the digital video data to generate final length video data.

9. The method of claim 7, wherein generating the motion video data file further comprises:
converting the final length transparent background video data into a plurality of layers of still image data files; and
editing each of the plurality of still image data files to reduce an image size of each of the plurality of still image data files to generate the plurality of sequentially numbered transparent background still image data files.

10. The method of claim 9, wherein respective ones of the plurality of sequentially numbered transparent background still image files include at least one bitmap and/or a portable network graphics (PNG) file.

11. The method of claim 9, wherein the plurality of sequentially numbered transparent background still image files comprise a file including a plurality of layers that correspond to the plurality of sequentially numbered transparent background still image files.

12. The method of claim 9, wherein generating the motion video data file further comprises assembling the plurality of sequentially numbered transparent background still image data files into the motion video data file.

13. A system for providing expedited production of multi-angle video, the system comprising:
a video image capture device that is configured to capture a continuous visual image of a video subject in front of a substantially monochromatic background and generate digital video data corresponding to the continuous visual image at a recording rate defined in frames per second;
a dynamic stage that is configured to move the video subject relative to the video image capture device; and
a signal processing device that is configured to receive the digital video data and to generate a multi-angle video of the video subject including a transparent background.

14. The system of claim 13, wherein the signal processing device comprises a selective signal amplifier that is configured to receive the digital video data from the video image capture device and to amplify a portion of the digital video data corresponding to reflected light having a dominant wavelength that corresponds to the substantially monochromatic background.

15. The system of claim 13, wherein the signal processing device comprises a computing device that is operable to execute at least one video editing and/or processing application.

16. The system of claim 15, wherein the signal processing device further comprises a video capture interface that is configured to be communicatively coupled with the computing device and to receive a selectively amplified digital video data so that the video editing and/or processing application may be used to generate the compact multi-angle video of the video subject including a transparent background.

17. A method of generating a multi-angle video, the method comprising:
moving a video subject on a dynamic stage;
capturing video of the moving video subject as digital video data;
selectively amplifying portions of the digital video data;
editing the selectively amplified digital video data to remove the selectively amplified portions and to generate final length transparent background video data;
converting the final length transparent background video data into a plurality of layers of still image data files;
editing each of the plurality of still image data files to reduce an image size of each of the plurality of still image data files to generate a plurality of sequentially numbered transparent background still image data files; and
assembling the plurality of sequentially numbered transparent background still image data files into a motion video data file.
